(19) United States
(12) Patent Application Publication
(10) Pub. No.: US 2015/0215522 A1
(43) Pub. Date: Jul. 30, 2015

(54) IMAGING APPARATUS

(71) Applicant: Panasonic Intellectual Property Management Co., Ltd., Osaka (JP)

(72) Inventor: Hiromitsu EBISU, Osaka (JP)

(21) Appl. No.: 14/608,971

(22) Filed: Jan. 29, 2015

(30) Foreign Application Priority Data
Jan. 29, 2014 (JP) 2014-014042
Oct. 29, 2014 (JP) 2014-220006

(51) Int. Cl. H04N 5/232; G02B 7/28

(52) U.S. Cl. CPC H04N 5/23212; G02B 7/282

(57) ABSTRACT

An imaging apparatus according to an exemplary embodiment of the present disclosure has an autofocus controlling unit configured to perform an autofocus controlling process for adjusting a focus to a subject; a speed acquisition unit configured to acquire a moving speed of the imaging apparatus; and a controller configured to determine whether or not to enable the autofocus controlling process performed by the autofocus controlling unit. The controller disables the autofocus controlling process performed by the autofocus controlling unit in the case where the moving speed acquired by the speed acquisition unit is equal to or greater than a predetermined value.

### BACKGROUND

1. Field

The present disclosure relates to an imaging apparatus provided with an autofocus controller.

2. Description of the Related Art

Recently, data exchanging services such as a video calling and photograph transmission that use a camera-equipped terminal to provide the services between the camera-equipped terminal and a terminal at a distant place also equipped with a camera have come into wide use.

For example, there has been a service that provides a video calling between a video calling terminal installed in each seat in an aircraft and a video calling terminal installed on the ground via a repeater, radio antennas on the aircraft and on the ground, and a communication satellite.

In the video calling and the photograph transmission, an autofocus controlling process for automatically adjusting a focal position of lenses in the camera to a subject is essential. Therefore, most of widely used video cameras and still cameras are provided with autofocus controllers.

With that autofocus controlling process, the video cameras and the still cameras can automatically adjust the focal position of the lenses to the subject even in the case where a position of a user changes or an installed condition of the camera changes. As a result, the video cameras and still cameras can guarantee clearness of captured images and captured videos.

Unexamined Japanese Patent Publication No. H08-079596 discloses a technique related to an autofocus controller configured to automatically adjust the focal position by detecting a speed of an image-forming position change.

### SUMMARY

An imaging apparatus according to an exemplary embodiment of the present disclosure is an imaging apparatus used in a moving object and is provided with an imaging unit, an autofocus controlling unit, a speed acquisition unit, and a controller. The imaging unit is provided with a plurality of lenses and configured to capture an image of a subject. The autofocus controlling unit is configured to automatically adjust a focal position of the lenses to the subject. The speed acquisition unit is configured to acquire a moving speed. The controller disables the autofocus controlling process performed by the autofocus controlling unit in a case where the moving speed acquired by the speed acquisition unit is equal to or greater than a predetermined value.

### BRIEF DESCRIPTION OF DRAWINGS

FIG. 1 is a schematic diagram of a video calling system that includes an imaging apparatus according to an exemplary embodiment of the present disclosure;

FIG. 2 is an enlarged view of a video calling terminal which is included in the video calling system of FIG. 1 and installed in an aircraft;

FIG. 3 is an enlarged view of a ground video calling terminal configured to communicate with the video calling terminal in the aircraft of FIG. 2;

FIG. 4 is a block diagram illustrating a configuration of a camera mounted on the video calling terminal in the aircraft of FIG. 2; and

FIG. 5 is a flow chart showing a switching control flow to disable or enable an autofocus controlling process in the video calling terminal in the aircraft of FIG. 2.

### DETAILED DESCRIPTION

Exemplary embodiments will be described in detail below with reference to the drawings as required.

However, an excessively detailed description may be omitted. For example, a detailed description of an already well-known matter and a repetitive description of substantially the same configuration may be omitted. All of such omissions are intended to facilitate understanding by those skilled in the art by preventing the description below from becoming unnecessarily redundant.

The inventor provides the accompanying drawings and the description below for those skilled in the art to fully understand the present disclosure and does not intend to limit the subject matter described in the claims to the accompanying drawings and the description below.

### First Exemplary Embodiment

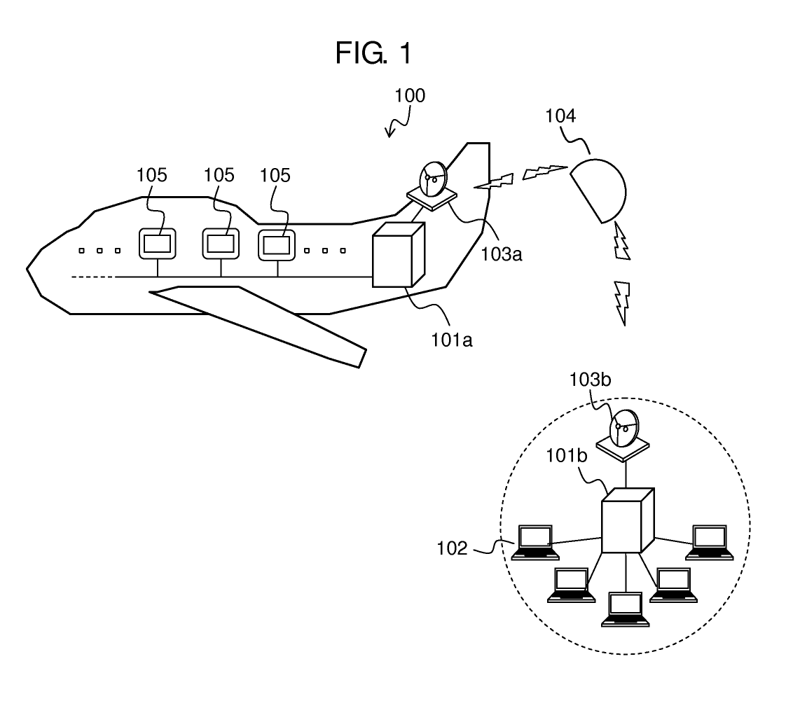

An exemplary embodiment of the present disclosure will be described below with reference to FIG. 1 to FIG. 5. First, before describing a specific exemplary embodiment, the exemplary embodiment of the present disclosure will be outlined with reference to FIG. 1 to FIG. 3.

Configuration of Video Calling System 100

FIG. 1 is a diagram schematically illustrating a configuration of video calling system 100 that includes an imaging apparatus according to the present exemplary embodiment.

As illustrated in FIG. 1, video calling system 100 includes a plurality of video calling terminals 105 as an example of the imaging apparatus, repeater 101a, radio antenna 103a, a plurality of video calling terminals 102 as an imaging apparatus, repeater 101b, radio antenna 103b, and communication satellite 104.

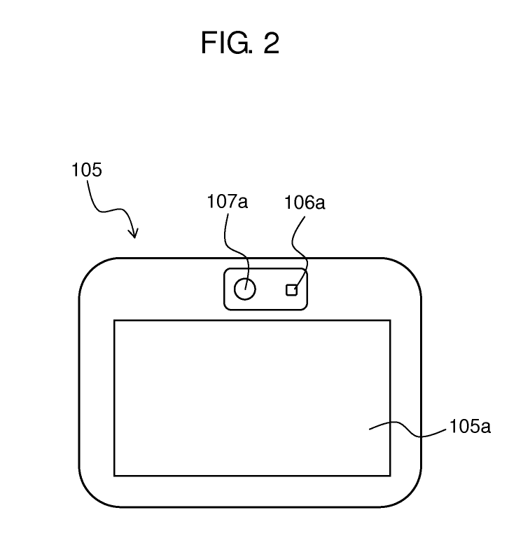

The plurality of video calling terminals 105, each of which is provided with display 105a, microphone 106a, and camera 107a, are associated with respective seats in aircraft 10 and installed in the seats. As illustrated in FIG. 2, when a user is talking with a person on the other end of the video calling over video calling terminal 105, video calling terminal 105 picks up voice of the user by microphone 106a and also captures an image of the user by camera 107a while displaying a face of the person on the other end on display 105a.

Repeater 101a has a wired connection or a wireless connection with each of video calling terminals 105 in aircraft 10 and radio antenna 103a to relay communication made by the video calling terminal 105.

Radio antenna 103a wirelessly communicates with communication satellite 104 which is outside of aircraft 10.

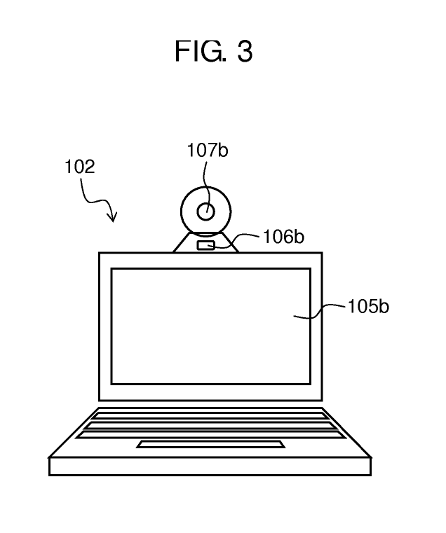

Each of the plurality of video calling terminals 102 is a computer that is installed on each location on the ground and that supports video calling. As illustrated in FIG. 3, video calling terminal 102 is provided with display 105b, microphone 106b, and camera 107b. When a user is talking with a person on the other end of the video calling over video calling terminal 102, video calling terminal 102 picks up voice of the user by microphone 106b and also captures an image of the user by camera 107b while displaying a face of the person on the other end on display 105b.

Repeater 101b has a wired connection or a wireless connection with each of the plurality of video calling terminals 102 in each location on the ground and radio antenna 103b to relay communication made by each video calling terminal 102.

Radio antenna 103b wirelessly communicates with communication satellite 104.

Communication satellite 104 relays communication between aircraft 10 and the ground.

Meanwhile, in the present exemplary embodiment, a unique IP address is assigned to each of video calling terminals 105 and 102. Then, the communication is performed on the basis of the TCP/IP protocol.

In addition, the transmission format for video data and audio data used in the present exemplary embodiment is MPEG2-TS defined in ISO/IEC13818-1. Further, a network used for communication between the video calling terminals in aircraft 10 and on the ground, the repeater, and the radio antennas is the Ethernet (registered trademark) defined in IEEE802.3 specification. Yet further, “Ku-band” which is a frequency band ranging from 12 GHz to 18 GHz is used for wireless communication between radio antennas 103a, 103b and communication satellite 104.

However, it should be noted that the respective communication methods and transmission systems are not limited to the above described examples and the other publicly known methods may be adopted.

Video Calling Terminal 105

Now, video calling terminal 105 will be described in detail.

Video calling terminal 105 sends out information including a video, a still image, or the like captured by camera 107a to repeater 101a via the network. Further, video calling terminal 105 displays a video received via the network on display 105a.

In addition, a software program for performing the video communication is installed on video calling terminal 105. The user can make video calling by executing the software program and logging onto a web site for exclusive use.

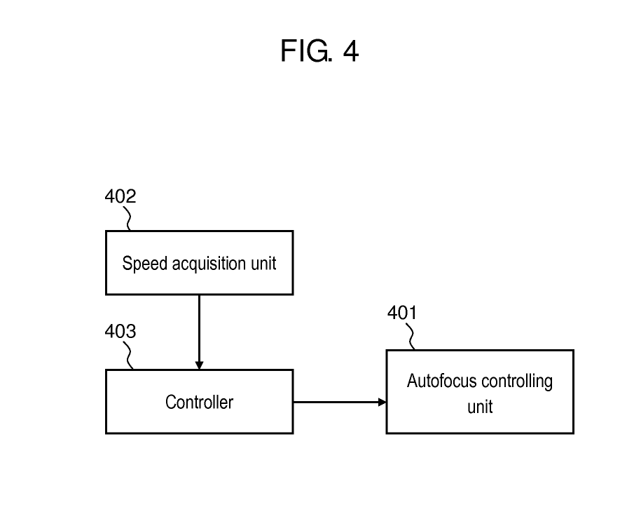

FIG. 4 is a block diagram illustrating a configuration of camera 107a mounted on video calling terminal 105.

Incidentally, it is assumed that the same configuration as that of camera 107a of video calling terminal 105 is adopted for camera 107b mounted on video calling terminal 102, and therefore, the description of camera 107b will be omitted below.

Camera 107a as an example of the imaging unit, mounted on video calling terminal 105 is provided with autofocus controlling unit 401, speed acquisition unit 402, and controller 403. Further, as illustrated in FIG. 2, camera 107a is mounted on a surface on the same side of display 105a of video calling terminal 105 and captures an image, for example, of the user talking on the video calling terminal 105.

Autofocus controlling unit 401 employs a phase difference method and a contrast method and performs an autofocus controlling process for automatically adjusting the focus of lenses in camera 107a to a subject.

Incidentally, the phase difference method is a method for dividing a light beam entered from the lens into two rays, guiding the rays into dedicated sensors, and determining the direction and the amount of focus based on a distance between two formed images. On the other hand, the contrast method is a method for adjusting the focus by searching for a point where an intensity difference, i.e., a contrast, peaks while moving a focusing lens based on a video captured by the imaging unit.

Speed acquisition unit 402 acquires a moving speed of video calling terminal 105, i.e., camera 107a, which agrees with a moving speed of aircraft 10.

Controller 403 has control of whether or not to enable autofocus controlling unit 401 based on speed information acquired by speed acquisition unit 402.

Incidentally, camera 107a of video calling terminal 105 installed in aircraft 10 always vibrates during a flight. Therefore, autofocus controlling unit 401 are always operating and the focusing lens is kept driven, which accelerates deterioration of a driver and shortens a product life.

Then, in the present exemplary embodiment, video calling terminal 105 acquires the moving speed of aircraft 10, i.e., video calling terminal 105, by speed acquisition unit 402 illustrated in FIG. 4, and based on the moving speed, video calling terminal 105 determines whether to enable or disable the autofocus controlling process of autofocus controlling unit 401.

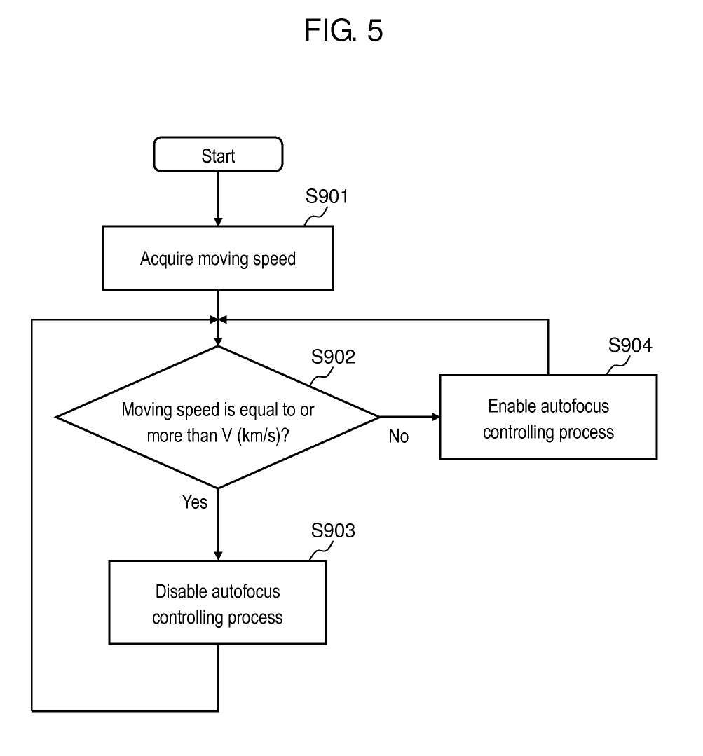

Specifically, as shown in FIG. 5, first in step S901, video calling terminal 105 acquires the moving speed of aircraft 10, i.e., video calling terminal 105, by speed acquisition unit 402 such as a GPS (Global Positioning System) or the like mounted on camera 107a.

Next, in step S902, controller 403 confirms whether the moving speed acquired by speed acquisition unit 402 is equal to or more than a predetermined threshold V (km/s) or not.

In that case, on the condition that the moving speed is equal to or more than the threshold V (km/s), controller 403 estimates that camera 107a is used in an environment in which camera 107a undergoes vibration and shocks. As a result, in the case where the moving speed equal to or more than the threshold V is acquired, video calling terminal 105 according to the present exemplary embodiment controls autofocus controlling unit 401 to disable the autofocus controlling process in step S903.

On the other hand, on the condition that the moving speed acquired by speed acquisition unit 402 is smaller than the predetermined threshold V (km/s), controller 403 estimates that camera 107a is not used in an environment in which camera 107a undergoes vibration and shocks. As a result, in that case, video calling terminal 105 controls autofocus controlling unit 401 to enable the autofocus controlling process in step S904.

Usually, the autofocus controlling process is necessary for making a video call or capturing an image by using camera 107a. However, a distance between camera 107a that is installed in a moving object such as aircraft 10 and the subject is almost constant. Therefore, video calling terminal 105 is not required to dynamically adjust the focus while camera 107a is used.

In the present exemplary embodiment, by taking account of the above described circumstances, video calling terminal 105 enables a process of automatically adjusting the focal position of camera 107a by the autofocus controlling process while the moving object such as aircraft 10 stops. On the other hand, while the moving object such as aircraft 10 is travelling, camera 107a is in an environment in which camera 107a is likely to undergo vibration and shocks, therefore, video calling terminal 105 disables the autofocus controlling process performed by autofocus controlling unit 401.

As a result, while aircraft 10 is traveling, video calling terminal 105 can guarantee clearness of captured images and captured videos equal to or more than a certain quality by fixing the focal position. Further, since the autofocus controlling process is not performed during a traveling period of aircraft 10 in which camera 107a may undergo vibrations and the like, deterioration of the driver for autofocus controlling unit 401 can be suppressed. As a result, in an environment in which camera 107a is likely to undergo vibration and shocks, video calling terminal 105 can effectively prevent a product life of the driver for autofocus controlling unit 401 from being shortened.

It should be noted that a distance between camera that is installed in the moving object such as aircraft 10 or a train and the subject is kept almost constant. Therefore, video calling terminal 105 is not required to dynamically adjust the focal position while the moving object is traveling, and only has to adjust the focal position while the moving object stops.

### Other Exemplary Embodiments

The exemplary embodiment has been described above as an example of the technology of the present disclosure. For that purpose, the accompanying drawings and the detailed description have been provided.

Therefore, the constituent elements shown and described in the accompanying drawings and the detailed description may include not only the constituent element necessary to solve the problem but also the constituent element unnecessary to solve the problem for the purpose of exemplifying the above described technology. Accordingly, it should not be instantly understood that the unnecessary constituent element is necessary only because the unnecessary constituent element is shown in the accompanying drawings or described in the detailed description.

Meanwhile, since the above described exemplary embodiments are for exemplifying the technology of the present disclosure, various changes, substitutions, additions, omissions, and the like may be made to the exemplary embodiments without departing from the scope of the claims and the equivalent of the claims.

[A]

The above described exemplary embodiment has been described by taking an example of determining whether to enable or disable the autofocus controlling process based on the moving speed of the moving object such as aircraft 10, i.e., video calling terminal 105. However, the present disclosure is not limited to that.

For example, video calling terminal 105 may control by using the other conditions such as a height of the imaging apparatus or the moving object or an operating state of an engine of the moving object.

In that case, for example, the imaging apparatus may disable the autofocus controlling process of the imaging apparatus in the case where the height of aircraft 10 is equal to or more than a predetermined value, and the imaging apparatus may disable the autofocus controlling process of the imaging apparatus in the case where the height is smaller than the predetermined value.

Alternatively, the imaging apparatus may disable the autofocus controlling process when the imaging apparatus detects that the engine of the moving object such as aircraft 10 starts, and the imaging apparatus may enable the autofocus controlling process when the engine of the moving object is not running.

[B]

The above described exemplary embodiment has been described by taking an example of autofocus controlling of camera 107a in the video calling between aircraft 10 and the ground. However, the present disclosure is not limited to that.

For example, the technology of the present disclosure can also be applied to the autofocus controller of the imaging apparatus in video calling, photograph taking, or data transmission between the other kinds of locations such as between a ground location A and a ground location B or between the inside of a train and a ground location.

[C]

The above described exemplary embodiment has been described by taking an example of directly acquiring the moving speed of camera 107a which moves with aircraft 10 by using the GPS mounted on camera 107a of video calling terminal 105 as speed acquisition unit 402. However, the present disclosure is not limited to that.

For example, while video calling terminal 105 is traveling by aircraft, video calling terminal 105 may indirectly acquire the moving speed of the imaging apparatus by accessing an aircraft server or the like set in the aircraft to acquire information about the moving speed of the aircraft.

Alternatively, while video calling terminal 105 is in a moving object such as an aircraft and traveling, video calling terminal 105 may directly acquire the moving speed of the imaging apparatus by using a speed sensor mounted on the imaging apparatus.

[D]

A moving object in which the imaging apparatus according to the exemplary embodiments of the present disclosure is used has been described by taking aircraft 10 as an example. However, the exemplary embodiments of the present disclosure are not limited to that.

For example, the exemplary embodiments of the present disclosure may be applied to the imaging apparatus that is used in an environment that is likely to produce vibrations or shocks such as a transportation means like a train, a bus, an automobile, or a ship or a construction vehicle used in a construction site other than an aircraft.

The imaging apparatus according to the exemplary embodiments of the present disclosure can be applied to an imaging apparatus installed in various moving objects such as an aircraft, a train, an automobile, a ship, or a construction vehicle.

What is claimed is:

1. An imaging apparatus used in a moving object comprising:
an imaging unit which is provided with a plurality of lenses and configured to capture an image of a subject;
an autofocus controlling unit configured to automatically adjust a focal position of the lenses with respect to the subject;
a speed acquisition unit configured to acquire a moving speed; and
a controller configured to disable an autofocus controlling process performed by the autofocus controlling unit in a case where the moving speed acquired by the speed acquisition unit is equal to or greater than a predetermined value.

2. The imaging apparatus according to claim 1,
wherein the controller enables the autofocus controlling process performed by the autofocus controlling unit in a case where the moving speed acquired by the speed acquisition unit is smaller than the predetermined value.

3. The imaging apparatus according to claim 1,
wherein the speed acquisition unit is a sensor configured to detect a moving speed.

4. The imaging apparatus according to claim 1,
wherein the speed acquisition unit indirectly acquires a moving speed by acquiring a moving speed of the moving object.

5. An imaging apparatus used in a moving object comprising:
an imaging unit which is provided with a plurality of lenses and configured to capture an image of a subject;
an autofocus controlling unit configured to automatically adjust a focal position of the lenses with respect to the subject;
a height acquisition unit configured to acquire a height of a current position; and
a controller configured to disable an autofocus controlling process performed by the autofocus controlling unit in a case where the height acquired by the height acquisition unit is equal to or greater than a predetermined value.

6. The imaging apparatus according to claim 5,
wherein the controller enables the autofocus controlling process performed by the autofocus controlling unit in a case where the height acquired by the height acquisition unit is smaller than the predetermined value.

7. The imaging apparatus according to claim 5,
wherein the height acquisition unit is a sensor configured to detect a height of a current position.

8. The imaging apparatus according to claim 5,
wherein the height acquisition unit indirectly acquires a height by acquiring a height of the moving object.
